(19) United States
(12) Patent Application Publication
(10) Pub. No.: US 2007/0046166 A1
(43) Pub. Date: Mar. 1, 2007

(54) Cold cathode electron source and electron tube using the same

(75) Inventors: Tomoyuki Okada, Hamamatsu-shi (JP); Tatsuya Matsumura, Hamamatsu-shi (JP); Tooru Yamamoto, Hamamatsu-shi (JP)

Correspondence Address: DRINKER BIDDLE & REATH (DC), 1500 K STREET, N.W., SUITE 1100, WASHINGTON, DC, 20005-1209, US

(73) Assignee: Hamamatsu Photonics K.K.

(21) Appl. No.: 11/590,865

(22) Filed: Nov. 1, 2006

Related U.S. Application Data
(63) Continuation-in-part of application No. PCT/JP05/09352, filed on May 23, 2005.

(30) Foreign Application Priority Data
May 31, 2004 (JP) P2004-161911
May 31, 2004 (JP) P2004-161645

(51) Int. Cl. H01J 1/02

(52) U.S. Cl. 313/309

(57) ABSTRACT

There is disclosed a cold cathode electron source includes: a first conductive member, having an end face and an electron emission layer that is formed on the end face and made of an electron emitting material; and a second conductive member, having a hollow portion that enables insertion of the first conductive member in a first direction substantially perpendicular to the end face, and an opening portion that passes through toward the hollow portion; and wherein the first conductive member is fitted into the second conductive member, is positioned in the first direction with respect to the second conductive member by abutting the second conductive member in the first direction, the first conductive member exposing a surface of the electron emission layer from the opening portion.

### CROSS-REFERENCE TO RELATED APPLICATIONS

This is a Continuation-In-Part application of International Patent application serial No. PCT/JP2005/009352 filed on May 23, 2005 now pending.

### BACKGROUND OF THE INVENTION

1. Field of the Invention

The present invention relates to a cold cathode electron source and an electron tube using the same.

2. Related Background Art

In place of hot cathodes that are used as electron emission sources in conventional electron tubes, etc., cold cathodes are coming to be used as compact electron emission sources of low consumption power. As arts of this field, there are devices described in Japanese Published Unexamined Patent Application No. 2001-250496 and Japanese Published Unexamined Patent Application No. 2003-100243. With an X-ray generating device described in the former, that is, Japanese Published Unexamined Patent Application No. 2001-250496, a cold cathode, having an electron emission layer, formed on a front face from carbon nanotubes, is supported via an insulator inside the device. In a periphery of the cold cathode are fixed a Wehnelt electrode that causes electrons, emitted from the cold cathode, to be incident on a target, and an extraction electrode that adjusts the amount of electrons emitted. By applying a voltage between the cold cathode and the target of the X-ray generating device, electrons are emitted toward the target from the cold cathode.

### SUMMARY OF THE INVENTION

With the cold cathode disposed in the above-described X-ray generating device, the carbon nanotube electron emission layer is formed on a cathode base. When such a cold cathode is disposed inside an X-ray tube or other electron tube, the amount of electrons emitted from the cold cathode depends, in addition to the voltages applied to the respective electrodes, on distances between the cold cathode and the respective electrodes in the electron emission direction. Thus to obtain a uniform electron emission amount, the cold cathode must be disposed at a priorly determined position with respect to the respective electrodes, such as the Wehnelt electrode and the extraction electrode. However, due to the tolerance of a supporting member, etc., it was difficult to accurately position the conventional cold cathode with respect to the respective electrodes inside the electron tube, etc.

An object of the present invention is thus to provide a cold cathode electron source, by which stable manufacture of electron sources, having the same characteristics and being adjusted in electron emission amount, is realized readily, and an electron tube that uses this cold cathode electron source.

A cold cathode electron source according to the present invention includes: a first conductive member, having an end face and an electron emission layer that is formed on the end face and made of an electron emitting material; and a second conductive member, having a hollow portion that enables insertion of the first conductive member in a first direction substantially perpendicular to the end face, and an opening portion that passes through toward the hollow portion; and wherein the first conductive member is fitted into the second conductive member, is positioned in the first direction with respect to the second conductive member by abutting the second conductive member in the first direction, the first conductive member exposing a surface of the electron emission layer from the opening portion.

Furthermore, a cold cathode electron source according to the present invention includes: a first conductive member, having an end face, an electron emission layer that is formed on the end face and made of an electron emitting material, and a first screw portion that is formed on a side face; and a second conductive member, having a hollow portion that enables insertion of the first conductive member in a first direction substantially perpendicular to the end face, an opening portion that passes through toward the hollow portion, and a second screw portion that is formed on at least either one of a wall face of the hollow portion and a wall face of the opening portion and is screw engageable with the first screw portion; and wherein the first conductive member is positioned, with respect to the second conductive member, in a second direction substantially parallel to the end face by the first screw portion and the second screw portion being screwed together, the first conductive member being positioned in the first direction with respect to the second conductive member by abutting the second conductive member in the first direction, the first conductive member exposing a surface of the electron emission layer from the opening portion.

An electron tube according to the present invention comprises: any of the above-described cold cathode electron sources according to the present invention; and a vacuum container that houses the cold cathode electron source.

### BRIEF DESCRIPTION OF THE DRAWINGS

FIG. 1 is a sectional view taken along an axial direction of an X-ray tube according to a first embodiment of an electron tube according to the present invention;

FIG. 2 is an enlarged sectional view of principal portions of the X-ray tube of FIG. 1;

FIG. 3 is a graph of an electric field strength at a front face of a cold cathode electron source of the X-ray tube of FIG. 2;

FIG. 4 is an enlarged sectional view of principal portions taken along an axial direction of an X-ray tube according to a second embodiment of an electron tube according to the present invention;

FIG. SA to FIG. 5H show sectional views of modification examples of the cold cathode electron source according to the first embodiment;

FIG. 6A and FIG. 6B show sectional views of other modification examples of the cold cathode electron source according to the first embodiment;

FIG. 7A to FIG. 7H show sectional views of modification examples of the cold cathode electron source according to the second embodiment;

FIG. 8A to FIG. 8H show sectional views of other modification examples of the cold cathode electron source according to the second embodiment;

FIG. 9A and FIG. 9B show sectional views of other modification examples of the cold cathode electron source according to the second embodiment;

FIG. 10 is a sectional view taken along an axial direction of an X-ray tube according to a third embodiment of an electron tube according to the present invention;

FIG. 11 is an enlarged sectional view of principal portions of the X-ray tube of FIG. 10;

FIG. 12 is a graph of an electric field strength at a front face of a cold cathode electron source of the X-ray tube of FIG. 11;

FIG. 13 is an enlarged sectional view of principal portions taken along an axial direction of an X-ray tube according to a fourth embodiment of an electron tube according to the present invention;

FIG. 14A to FIG. 14H show sectional views of modification examples of the cold cathode electron source according to the third embodiment;

FIG. 15A to FIG. 15H show sectional views of modification examples of the cold cathode electron source according to the fourth embodiment;

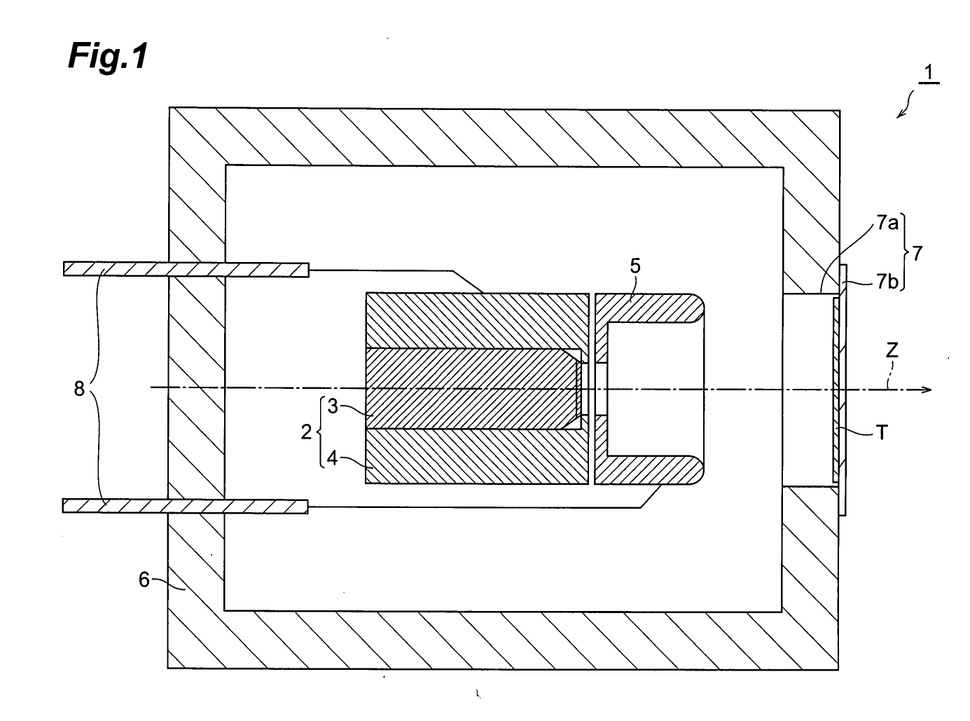

FIG. 1 6A to FIG. 1 6H show sectional views of other modification examples of the cold cathode electron source according to the fourth embodiment; and

FIG. 17 is a sectional view of another modification example of the cold cathode electron source according to the fourth embodiment.

FIG. 18A to FIG. 18C show sectional views of other modification examples of the cold cathode electron source according to the fourth embodiment.

### DESCRIPTION OF THE PREFERRED EMBODIMENTS

Preferred embodiments of an electron tube according to the present invention shall now be described with reference to the drawings. In the description of the drawings, portions that are the same or equivalent shall be provided with the same symbol and redundant description shall be omitted. The dimensional proportions of the drawings do not necessarily match those of the description.

### First Embodiment

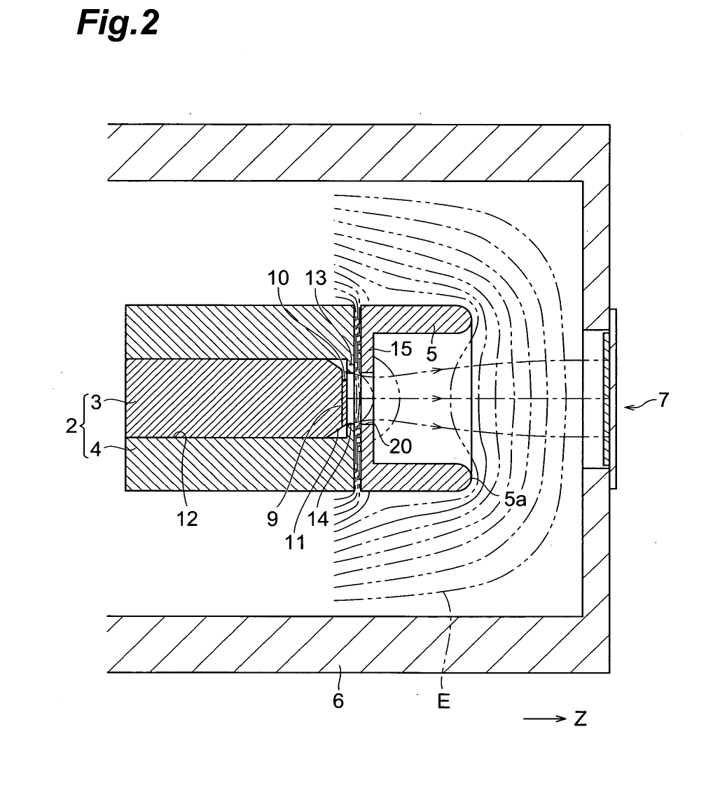

FIG. 1 is a sectional view taken along an axial direction of an X-ray tube according to a first embodiment of an electron tube according to the present invention. FIG. 2 is an enlarged sectional view of principal portions of the X-ray tube of FIG. 1. An interior of the X-ray tube 1 shown in FIG. 1 is maintained at vacuum. The X-ray tube 1 has a cold cathode electron source 2 that emits electrons, an extraction electrode 5 that extracts electrons from the cold cathode electron source 2, a vacuum container 6 that houses the cold cathode electron source 2 and the extraction electrode 5, an X-ray transmitting window 7 for taking out the generated X-rays to the exterior, and a target T. The X-ray transmitting window 7 includes an X-ray transmitting window portion 7a that is formed at an end in an electron emitting direction of the vacuum container 6 and an X-ray transmitting window member 7b that, by being disposed so as to cover the X-ray transmitting window portion 7a from the exterior, maintains the vacuum. The target T that generates X-rays upon incidence of the electrons from the cold cathode electron source 2 is formed at an inner side of the X-ray transmitting window member 7b. Connection terminals 8 pass through an end face at the side of vacuum container 6 opposite the X-ray transmitting window portion 7a. The connection terminals 8 supply voltages to the respective members of the cold cathode electron source 2 and to the extraction electrode 5. In the following, the direction of emission of electrons (right direction along the paper surface) in FIG. 1 and FIG. 2 shall be referred to as the Z-axis direction, the +Z direction shall be referred to as the “front,” and the −Z direction shall be referred to as the “rear” for the sake of description.

With the cold cathode electron source 2, a central conductor (first conductive member) 3, formed of a cylindrical metal material, is fitted into a cylindrical outer conductor (second conductive member) 4, made of a metal material. These are disposed so that a central axis of the central conductor 3 and a central axis of the outer conductor 4 are substantially matched and are parallel to the Z axis. As shown in FIG. 2, the central conductor 3 has a flat end face 9 at one end (front end). An inclined face 11 is formed by chamfering along an edge of the end face 9. An electron emission layer 10 made of an electron emitting material is formed as a film on the end face 9. In the solid state, the electron emitting material emits electrons according to the tunnel effect when an electric field is applied to its surface. Examples of such an electron emitting material include carbon-based materials, such as carbon nanotubes and diamond, and ceramic-based materials, having an amorphous carbon-based film formed on a surface, and due to being low in power consumption and high in chemical stability, carbon nanotubes are preferably used.

A method of laminating the electron emission layer 10, made of the electron emitting material, onto the end face 9 is not restricted to a particular method. For example, a method of coating a suspension, with which an organic solvent and a binder are added to carbon nanotubes, onto the end face 9 and then removing the organic solvent by baking can be cited. A method of depositing carbon nanotubes, diamond, etc., onto the end face 9 by CVD (Chemical Vapor Deposition) may also be used.

The outer conductor 4 that is disposed at an outer side of the central conductor 3 has a hollow portion 12 of circular cross-sectional shape that passes through in the Z direction. By an inner diameter of the hollow portion 12 being made substantially equal to an outer diameter of the central conductor 3, the outer conductor 4 is provided with a shape, with which the central conductor 3 can be fitted in a direction (first direction) perpendicular to the end face 9. At a front end of the hollow portion 12 is provided a ring-shaped protrusion 13 that extends inward and substantially perpendicular to the central axis of the outer conductor 4. An opening portion 14, having a circular cross section in a direction (second direction) parallel to the end face 9 and passing through toward the hollow portion 12, is defined by the protrusion 13. The hollow portion 12 and the opening portion 14 are formed so that the respective central axes thereof are substantially matched. The diameter of the opening portion 14 is made no greater than the diameter of the end face 9 of the central conductor 3.

In assembling the cold cathode electron source 2, the central conductor 3 is fitted into the hollow portion 12 of the outer conductor 4, and a front face of the electron emission layer 10 of the central conductor 3 abuts the protrusion 13 of the outer conductor 4. The central conductor 3 is thereby positioned, with respect to the outer conductor 4, in the direction perpendicular to the end face 9. At the same time, by a side face of the central conductor 3 contacting a wall face of the hollow portion 12 that makes up a portion of an inner wall of the outer conductor 4, the central conductor 3 is positioned, with respect to the outer conductor 4, in the direction parallel to the end face 9. By the central conductor 3 contacting the outer conductor 4, the central conductor 3 and the outer conductor 4 are made electrically continuous with each other. Of the surface of the electron emission layer 10 of the central conductor 3, a range defined by the opening portion 14 is exposed to the exterior from the opening portion 14. Here, by abutting the protrusion 13, the central conductor 3 is disposed so that the electron emission layer 10 does not protrude frontward from a front end of the opening portion 14.

The extraction electrode 5 is a cylindrical electrode that is substantially equal in outer diameter to the cold cathode electron source 2. The extraction electrode 5 is disposed at a predetermined position in front of the opening portion 14 of the cold cathode electron source 2 so that its central axis is substantially matched with the central axis of the cold cathode electron source 2. Because this positional relationship is reflected in the amount of electrons extracted from the cold cathode electron source 2, it may be set appropriately according to the desired electron amount. Also at a rear end of the extraction electrode 5 is formed a ring-like protrusion 15 that extends inward and substantially perpendicular to the central axis direction. The protrusion 15 defines an opening 20 that opposes and is of substantially the same shape as the opening portion 14.

Actions and effects of the X-ray tube 1 described above shall now be described with reference to FIG. 2.

When voltages are applied so that the potential of the extraction electrode 5 and the potential of the target T are higher than the potential of the central conductor 3 and the outer conductor 4 of the cold cathode electron source 2, a spatial field is formed between the cold cathode electron source 2 and the target T. FIG. 2 shows isoelectric lines E of the electric field that is thus formed. By a comparatively strong electric field being formed in front of the electron emission layer 10 of the central conductor 3 by the extraction electrode 5 as shown in this figure, electrons are emitted frontward from the electron emission layer 10. The emitted electrons pass through the opening 20 of the extraction electrode 5, are converged in the central axis direction by an electron lens formed by an open end 5a at the X-ray transmitting window 7 side of the extraction electrode 5, and are made incident on the target T efficiently. At the target T, X-rays are generated by the incidence of the electrons, and the generated X-rays are taken out frontward to the exterior from the X-ray transmitting window 7.

The amount of electrons emitted from the cold cathode electron source 2 in such an X-ray tube 1 varies according to the distance between the protrusion 15 of the extraction electrode 5 and the surface of the electron emission layer 10, the thickness in the Z direction of the protrusion 13 at the cold cathode electron source 2, and the positional relationship of the protrusion 13 and the surface of the electron emission layer 10. As an example of an X-ray source, with which the amount of electrons emitted from the cold cathode is controlled by the extraction electrode, there is the arrangement described in Japanese Published Unexamined Patent Application No. 2001-250496. With this X-ray source, the cathode, the extraction electrode, and the Wehnelt electrode which converges the emitted electrons onto the target, are disposed separately. Thus to obtain the desired electron emission amount, the cathode, the extraction electrode, and the Wehnelt electrode must be disposed at the respective positions without error.

In contrast, with the cold cathode electron source 2, the central conductor 3, having the electron emission layer 10 formed on the end face 9, is fitted into the hollow portion 12 of the outer conductor 4, and the central conductor 3 is positioned in the state of abutting the outer conductor 4 in the direction perpendicular to the end face 9. By thus forming the central conductor 3 and the outer conductor 4 to be in a desired positional relationship, the positioning of the central conductor 3 with respect to the outer conductor 4 in the direction perpendicular to the end face 9 is achieved readily, and fluctuations of the electric field distribution in a periphery of the electron emission layer 10 due to fluctuations of the positional relationship of the central conductor 3 and the outer conductor 4 among cold cathode electron sources 2 of the same structure are reduced. Consequently, stable manufacture of the cold cathode electron sources 2, having the same characteristics and the desired electron emission amount, can be realized. By positioning the cold cathode electron source 2 as the electron source of the X-ray tube 1 at the predetermined position with respect to the extraction electrode, the X-ray tube 1 of the X-ray amount based on the desired electron emission amount can be obtained. Also, because the opening portion 14, which exposes the electron emission layer 10 in the state in which the central conductor 3 abuts the outer conductor 4, is formed in the outer conductor 4, the electron emission range of the electron emission layer 10 is set readily.

Also with the cold cathode electron source 2, by the positioning of the central conductor 3 with respect to the outer conductor 4 in the direction parallel to the end face 9 being achieved at the same time, fluctuations of the electric field distribution in the periphery of the electron emission layer 10 due to fluctuations of the positional relationship of the central conductor 3 and the outer conductor 4 among cold cathode electron sources 2 of the same structure are reduced further. Stable manufacture of the cold cathode electron sources 2, having the same characteristics and the desired electron emission amount, can thus be realized, and by positioning the cold cathode electron source 2 as the electron source of the X-ray tube 1 at the predetermined position with respect to the extraction electrode, the X-ray tube 1 of the X-ray amount based on the desired electron emission amount can be obtained.

Meanwhile, in contrast to the arrangement of fitting the central conductor 3 into the outer conductor 4, employment of an arrangement, in which an outer conductor and a central conductor are made integral, is also possible. In this case, the electron emitting material may become deposited on portions corresponding to being portions of the outer conductor, etc., in the process of forming the electron emission layer. As a result, such phenomena as emission of electrons in unexpected directions, discharge across other electrodes, etc., may occur. In regard to this point, with the X-ray tube 1, because the outer conductor 4 and the central conductor 3 can be formed as separate members and the central conductor 3 can be incorporated in the hollow portion 12 of the outer conductor 4 after forming the electron emission layer 10 on the end face 9 of the central conductor 3, the deposition of the electron emitting material onto portions besides the end face 9 can be prevented. In this case, unintended electron emission and discharge from the electron emission layer 10 are prevented, and the process of forming the electron emission layer 10 is made efficient.

Also because the inclined face 11 is formed by chamfering on the central conductor 3, the central conductor 3 can be fitted smoothly into the outer conductor 4, flawing of the surface of the electron emission layer 10 can be prevented, and the process of assembling the cold cathode electron source 2 is made efficient.

Also with the cold cathode electron source 2, by the presence of the protrusion 13 that is equipotential to the central conductor 3, the difference between the electric field strength at an edge of the electron emission layer 10 and the electric field strength at a center of the electron emission layer 10 can be reduced, and thus a uniform electron emission distribution can be obtained.

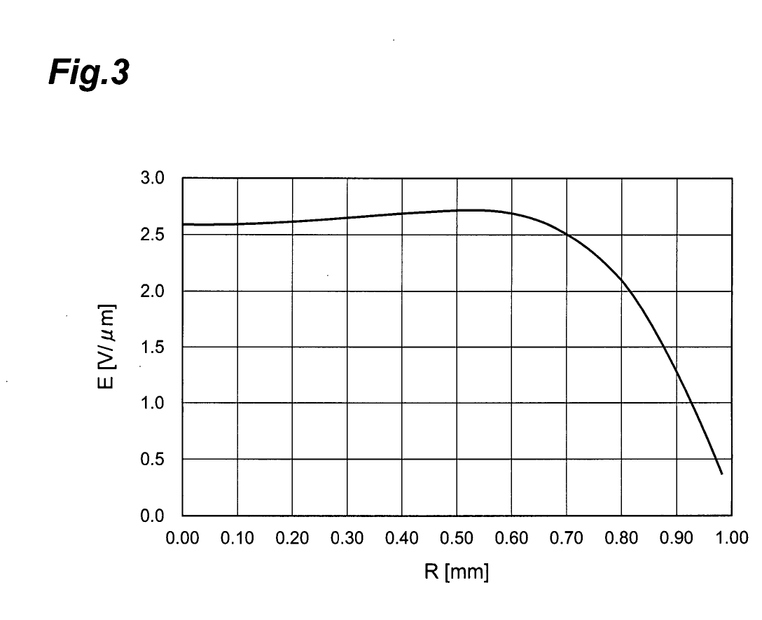

FIG. 3 is a graph of the electric field strength at the front face of the cold cathode electron source 2 of the X-ray tube of FIG. 2. Here, the diameter of the electron emission layer 10 of the cold cathode electron source 2 is 2.0 mm, the distance between the outer conductor 4 and the extraction electrode 5 is 0.25 mm, and voltages are applied to the respective electrodes so that the potential of the extraction electrode 5 is +2500V higher than the potential of the cold cathode electron source 2. In this figure, the abscissa indicates the distance R [mm] from the central axis of the central conductor 3 near the electron emission layer 10 and the ordinate indicates the electric field strength E [V/μm] in the Z direction. As shown in the figure, the electric field strength in the Z direction near the electron emission layer 10 is maintained substantially fixed up to near R=0.70 [mm].

### Second Embodiment

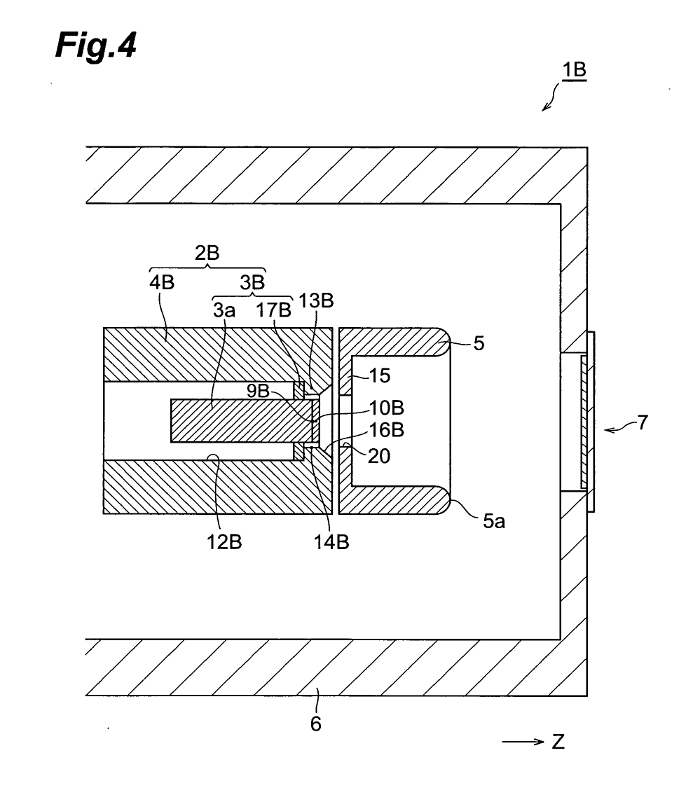

A second embodiment of the present invention shall now be described. FIG. 4 is an enlarged sectional view of principal portions taken along an axial direction of an X-ray tube according to the second embodiment of an electron tube according to the present invention. The X-ray tube 1 B according to this embodiment differs from that of the first embodiment in the shapes of the central conductor and the outer conductor and in that the central conductor has an insulating portion.

As shown in FIG. 4, with a cold cathode electron source 2B of the X-ray tube 1B, a central conductor (first conductive member) 3B having a conductive portion 3a, made of a cylindrical metal material, is fitted into a cylindrical outer conductor (second conductive member) 4B, made of a metal material. A flat end face 9B is formed at one end (front end) of the central conductor 3B. An electron emission layer 10B made of an electron emitting material is formed as a film on the end face 9B.

The outer conductor 4B that is disposed at an outer side of the central conductor 3B has a hollow portion 12B of circular cross-sectional shape that passes through in the Z direction. The inner diameter of the hollow portion 12B is made larger than the outer diameter of the conductive portion 3a of the central conductor 3B. A ring-like protrusion 13B that extends inward and substantially perpendicular to a central axis of the outer conductor 4B is provided at a front end of the hollow portion 12B. An inclined face 16B that spreads towards the front is formed on the protrusion 13B. Also, an opening portion 14B that is circular in cross section in the direction parallel to the end face 9B and passes through toward the hollow portion 12B is defined by the protrusion 13B and the inclined face 16B that forms a portion of the protrusion 13B. Here, the hollow portion 12B and the opening portion 14B are substantially matched in their respective central axes. The diameter of the opening portion 14B is made no less than the diameter of the end face 9B of the central conductor 3B.

Furthermore, the central conductor 3B has a ring-like insulating portion 17B that is parallel to the end face 9B. This insulating portion 17B is fixed to the conductive portion 3a and forms a portion of the outer surface of the central conductor 3B. By this insulating portion 17B, the central conductor 3B is enabled to be fit into the hollow portion 12B in the direction perpendicular to the end face 9B. The outer diameter of the insulating portion 17B is substantially equal to the diameter (inner diameter) of the hollow portion 12B. The central conductor 3B is fitted into the hollow portion 12B with the insulating portion 17B abutting a wall face of the hollow portion 12B that forms a portion of the inner wall of the outer conductor 4B. When the central conductor 3B is completely fitted in the outer conductor 4B, the insulating portion 17B abuts the protrusion 13B. By the insulating portion 17B abutting the protrusion 13B, the electron emission layer 10B is positioned so as not to protrude frontward from the front end of the opening portion 14B.

In assembling the cold cathode electron source 2B, the central conductor 3B is fitted into the hollow portion 12B of the outer conductor 4B and the insulating portion 17B of the central conductor 3B abuts the protrusion 13B. The central conductor 3B is thereby positioned in the direction perpendicular to the end face 9B. By the insulating portion 17B also contacting the wall face of the hollow portion 12B in this process, the central conductor 3B is positioned, with respect to the outer conductor 4B, in the direction parallel to the end face 9B. By the insulating portion 17B thus abutting the outer conductor 4B, the central conductor 3B and the outer conductor 4B are electrically insulated from each other.

With the X-ray tube 1B described above, because the outer conductor 4B is electrically insulated from the central conductor 3B, the potential of the outer conductor 4B can be set independently of the central conductor 3B, and the amount of electrons extracted from the electron emission layer 10B can be controlled more finely while keeping fixed the electron converging effect by the extraction electrode 5. When the potential of the extraction electrode 5 is changed, because the field distribution in the space between the target T and the extraction electrode 5 changes as well, it is difficult to keep the electron converging effect fixed. However, this problem does not occur with the X-ray tube 1B, with which the potential of the outer conductor 4B can be controlled.

Also, though the potential at the edge of the front face of the electron emission layer 10B tends to rise in comparison to the potential at a central portion, by supplying a lower potential to the outer conductor 4B than to the central conductor 3B, the potential rise at the edge of the front face of the electron emission layer 10B can be restrained further to provide a more uniform electron emission distribution.

Furthermore, because by the inclined face 16B formed on the protrusion 13B of the outer conductor 4B, the potential of the extraction electrode 5 can readily permeate to the open space in front of the electron emission layer 10B, electrons are made readily emitted at a uniform emission distribution over a wide range frontward of the electron emission layer 10B and consequently, the electron emission amount increases.

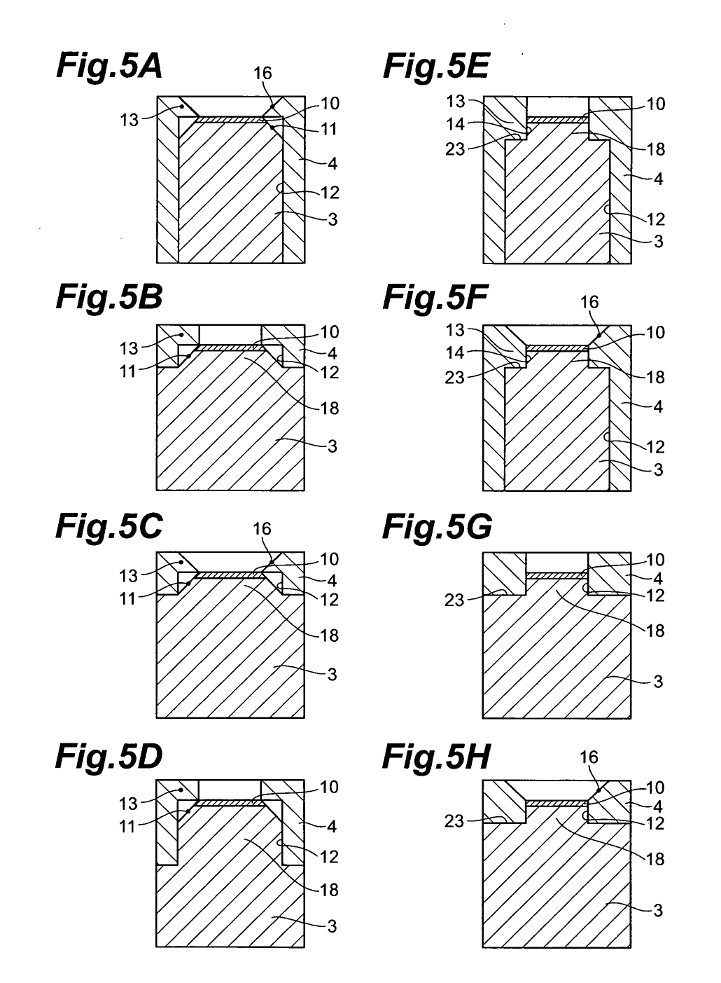

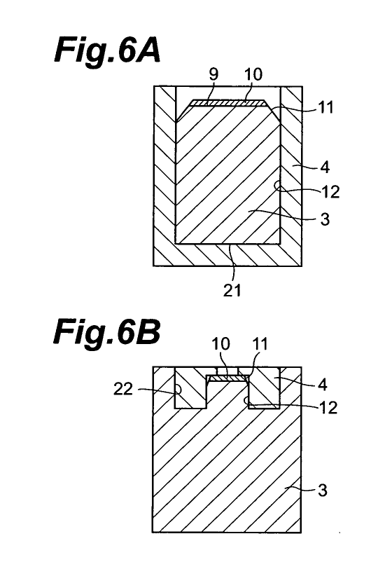

The present invention is not restricted to the respective embodiments described above, and various shapes besides those described above may be employed as the shape of the cold cathode electron source. FIG. 5A to FIG. 5H, FIG. 6A, and FIG. 6B show modification examples of the cold cathode electron source 2 according to the first embodiment. With the cold cathode electron source shown in FIG. 5A, an inclined face 16 that spreads toward the outer side is formed on the protrusion 13 of the outer conductor 4, and the inclined face 11 is formed by chamfering along the edge of the end face at the electron emission layer 10 side of the central conductor 3. With each of the cold cathode electron sources shown in FIG. 5B to FIG. 5D, the central conductor 3 has a protruding portion 18, which includes the end face at the electron emission layer 10 side, and is fitted into the outer conductor 4 by the fitting of the protruding portion 18 into the hollow portion 12.

With each of the cold cathode electron sources shown in FIG. 5E and FIG. 5F, the protruding portion 18 of the central conductor 3 is fitted into the opening portion 14 of the outer conductor 4, and the central conductor 3 is positioned in the axial direction by an end face 23, which is perpendicular to an outer peripheral surface of the protruding portion 18 of the central conductor 3, contacting the protrusion 13. With each of the cold cathode electron sources shown in FIG. 5E and FIG. 5F, the positioning in the direction parallel to the end face 9 may be achieved by the side face of the central conductor 3 abutting both the wall face of the hollow portion 12 and the wall face of the opening portion 14 that make up the inner walls of the outer conductor 4 or contacting one of either the wall face of the hollow portion 12 or the wall face of the opening portion 14. Furthermore, with each of the cold cathode electron sources shown in FIG. 5G and FIG. 5H, the outer conductor 4 does not have a protrusion 13 and one end of the hollow portion 12 serves in common as the opening portion 14. The central conductor 3 is fitted into the outer conductor 4 by the protruding portion 18 being fitted into the hollow portion 12.

With the cold cathode electron source shown in FIG. 6A, the outer conductor 4 has the hollow portion 12, into which the central conductor 3 can be fitted from an end face 21, disposed at the opposite side of the end face 9 and not having an electron emission layer formed thereon, and one end of the hollow portion 12 serves as the opening portion 14. In this case, a penetrating hole for venting air may be provided at a portion of the outer conductor 4 that faces the end face 21 so that the central conductor 3 can be fitted readily into the hollow portion 12. With the cold cathode electron source shown in FIG. 6B, a recess 22 that is substantially matched to the outer shape of the outer conductor 4 is formed in the central conductor 3, and when the central conductor 3 is fitted into the hollow portion 12 of the outer conductor 4, the outer conductor 4 is fitted into the recess of the central conductor 3 at the same time. With each of the cold cathode electron sources shown in FIG 5A to FIG. 5D, FIG. 6A, and FIG. 6B, the inclined face 11 does not have to be formed. Also with each of the cold cathode electron sources shown in FIG. 5E to FIG. 5H, the inclined face 11 may be formed. Likewise, with each of the cold cathode electron sources shown in FIG. 5D, FIG. 6A, and FIG. 6B, the inclined face 16 may be formed.

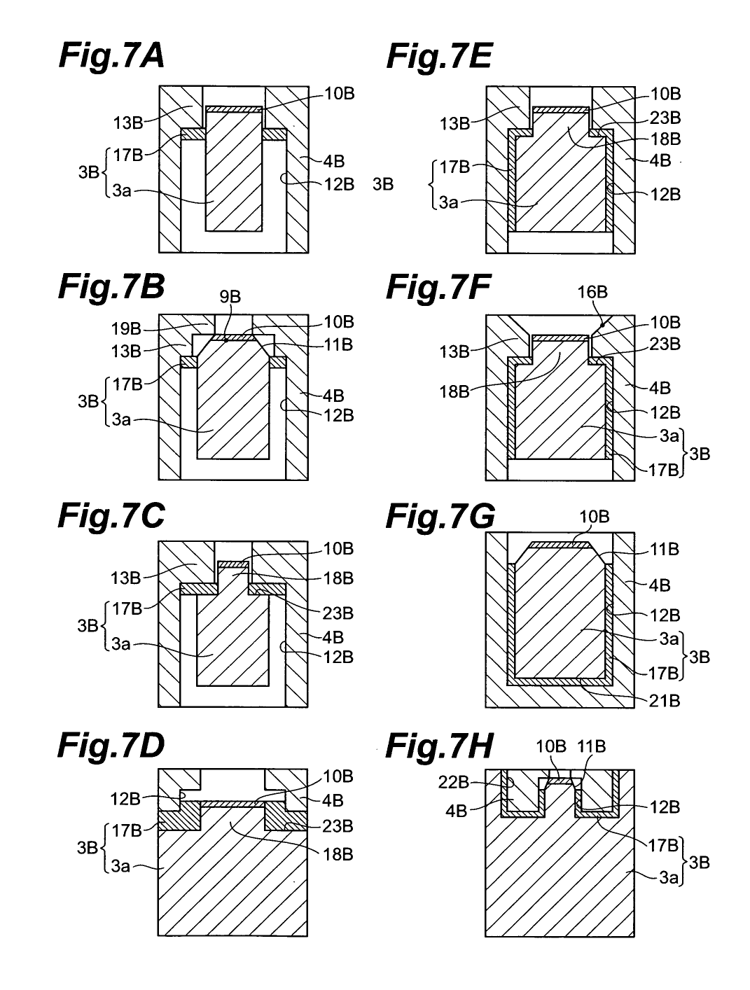

FIG. 7A to FIG. 7H show modification examples of the cold cathode electron source 2B according to the second embodiment. FIG. 7A shows an example of the cold cathode electron source that does not have the inclined face 16B. With the cold cathode electron source shown in FIG. 7B, an inclined face 11B is formed by chamfering along the end face 9B of the central conductor 3B, and a ring-like protrusion 19B is formed at an outer side in the axial direction of the protrusion 13B of the outer conductor 4B. The inner diameter of the protrusion 19B is made substantially equal to the diameter of the end face 9B of the central conductor 3B, and the protrusion 19B and the electron emission layer 10B are disposed so as not to contact each other.

With each of the cold cathode electron sources shown in FIG. 7C and FIG. 7D, a protruding portion 18B is formed on an electron emission side end face of the conductive portion 3a of the central conductor 3B, and this protruding portion 18B is inserted into the hollow portion 12B and is positioned via the insulating portion 17B. With the cold cathode electron source shown in FIG. 7D, by the insulating portion 17B abutting the end face of the outer conductor 4B at the inserting side, the central conductor 3B is positioned in the axial direction.

In contrast to the cold cathode electron source shown in FIG. 7C, each of the cold cathode electron sources shown in FIG. 7E and FIG. 7F has an arrangement in which the insulating portion 17B is formed and fixed on the entire side face of the conductive portion 3a of the central conductor 3B and on an end face 23B that is perpendicular to an outer peripheral surface of the protruding portion 18B. With each of the cold cathode electron sources shown in FIG. 7E and FIG. 7F, an insulating portion may furthermore be formed on the outer periphery of the protruding portion 18B. In this case, the positioning in the direction parallel to the end face 9B may be achieved by the side face of the conductive portion 3a of the central conductor 3B contacting, via the insulating portion 17B, both or either of the wall face of the hollow portion 12B and the wall face of the opening portion 14B that make up the inner walls of the outer conductor 4B. FIG. 7G and FIG. 7H show cold cathode electron sources with shapes corresponding to those of FIG. 6A and FIG. 6B and having the insulating portion 17B. With the cold cathode electron source shown in FIG. 7G, to make the central conductor 3B fit readily into the hollow portion 12B or to secure electrical connection to the central conductor 3B, penetrating holes may be provided at portions of both the insulating portion 17B and the outer conductor 4B that face the end face 21B. With each of the cold cathode electron sources shown in FIG. 7B, FIG. 7G, and FIG. 7H, the inclined face 11B does not have to be formed. Also with each of the cold cathode electron sources shown in FIG. 7A and FIG. 7C to FIG. 7F, the inclined face 11B may be formed. Likewise, with each of the cold cathode electron sources shown in FIG. 7B to FIG. 7D, FIG. 7G, and FIG. 7H, the inclined face 16B may be formed.

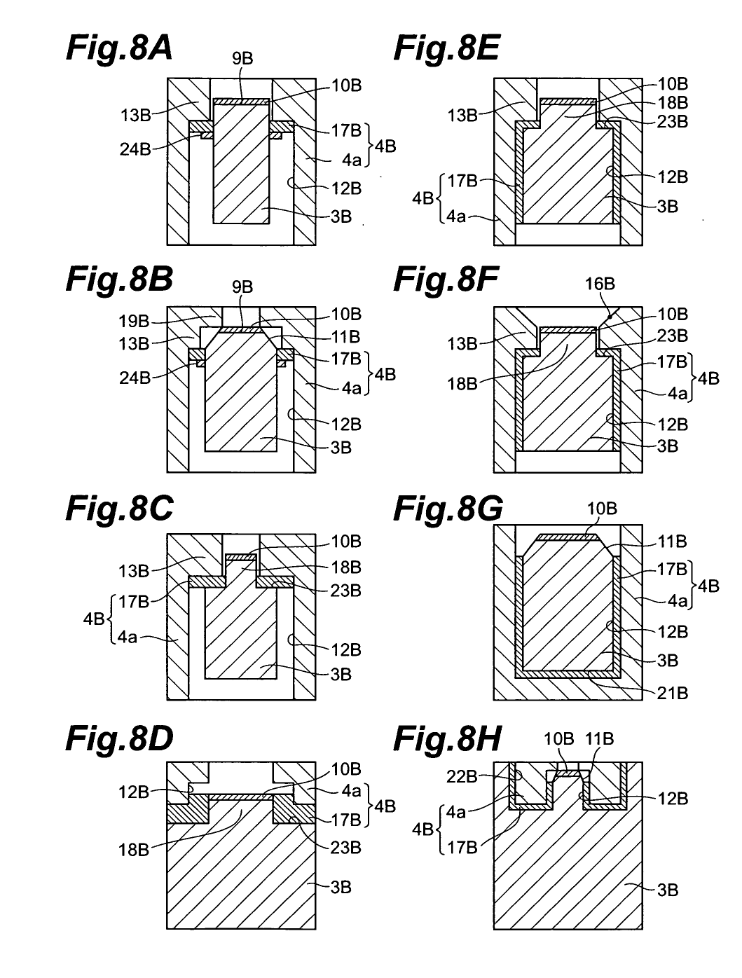

FIG. 8A to FIG. 8H show other modification examples of the cold cathode electron source 2B according to the second embodiment. The cold cathode electron sources shown in FIG. 8A to FIG. 8H correspond respectively to the cold cathode electron sources shown in FIG. 7A to FIG. 7H. With each of the cold cathode electron sources shown in FIG. 8A to FIG. 8H, the insulating portion 17B is mounted not on the conductive portion 3a of the central conductor 3B but on an inner wall of a cylindrically shaped conductive portion 4a of the outer conductor 4B. The insulating portion 17B thus forms at least a portion of the inner wall of the outer conductor 4B. With each of these cold cathode electron sources, the central conductor 3B abuts the insulating portion 17B in the direction of insertion and contacts the insulating portion 17B in the direction parallel to the end face 9B.

Specifically, with each of the cold cathode electron sources shown in FIG. 8A and FIG. 8B, the central conductor 3B has a stopper portion 24B that extends in the direction parallel to the end face 9B. The stopper portion 24B forms a portion of the outer surface of the central conductor 3B. The central conductor 3B is set in a desired positional relationship with respect to the outer conductor 4B by the stopper portion 24B abutting the insulating portion 17B in the insertion direction when the central conductor 3B is fitted into the outer conductor 4B. Consequently, the central conductor 3B is positioned in the direction perpendicular to the end face 9B. The stopper portion 24B may be formed integral to the central conductor 3B or may be fixed to the central conductor 3B.

With the cold cathode electron source shown in FIG. 8G, to make the central conductor 3B fit readily into the hollow portion 12B or to secure electrical connection to the central conductor 3B, penetrating holes may be provided at portions of both the insulating portion 17B and the conductive portion 4a of the outer conductor 4B that face the end face 21B. With each of the cold cathode electron sources shown in FIG. 8B, FIG. 8G, and FIG. 8H, the inclined face 11B does not have to be formed. Also with each of the cold cathode electron sources shown in FIG. 8A and FIG. 8C to FIG. 8F, the inclined face 11B may be formed. Likewise, with each of the cold cathode electron sources shown in FIG. 8B to FIG. 8D, FIG. 8G, and FIG. 8H, the inclined face 16B may be formed.

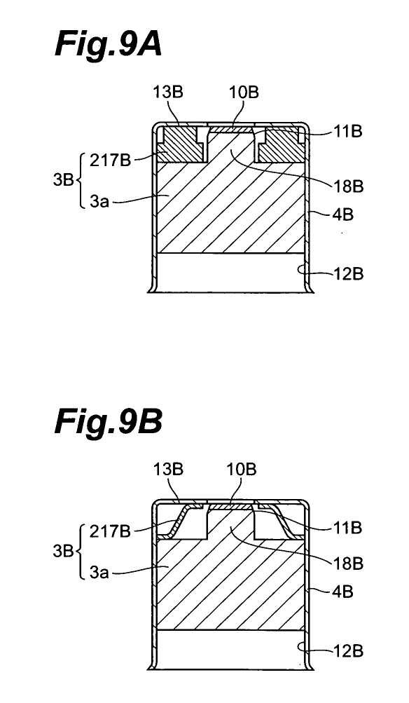

FIG. 9A and FIG. 9B show other modification examples of the cold cathode electron source 2B according to the second embodiment. With each of the cold cathode electron sources shown in FIG. 9A and FIG. 9B, the central conductor 3B has a ring-like conductive portion 217B instead of the insulating portion 17B. The conductive portion 217B is ,for example, a stainless-steel portion. The conductive portion 217B shown in FIG. 9A is formed by cutting work. The conductive portion 217B shown in FIG. 9B is formed by press work. This conductive portion 217B is fixed to the conductive portion 3a and forms a portion of the outer surface of the central conductor 3B. By this conductive portion 217B, the central conductor 3B is enabled to be fit into the hollow portion 12B in the direction perpendicular to the end face 9B. The outer diameter of the conductive portion 217B is substantially equal to the diameter (inner diameter) of the hollow portion 12B. The central conductor 3B is fitted into the hollow portion 12B with the conductive portion 217B abutting a wall face of the hollow portion 12B that forms a portion of the inner wall of the outer conductor 4B. When the central conductor 3B is completely fitted in the outer conductor 4B, the conductive portion 217B abuts the protrusion 13B. By the conductive portion 217B abutting the protrusion 13B, the electron emission layer 10B is positioned so as not to protrude frontward from the front end of the opening portion 14B.

With each of the cold cathode electron sources shown in FIG. 9A and FIG. 9B, the inclined face 11B does not have to be formed. Also with each of the cold cathode electron sources shown in FIG. 9A and FIG. 9B, the inclined face 16B may be formed.

### Third Embodiment

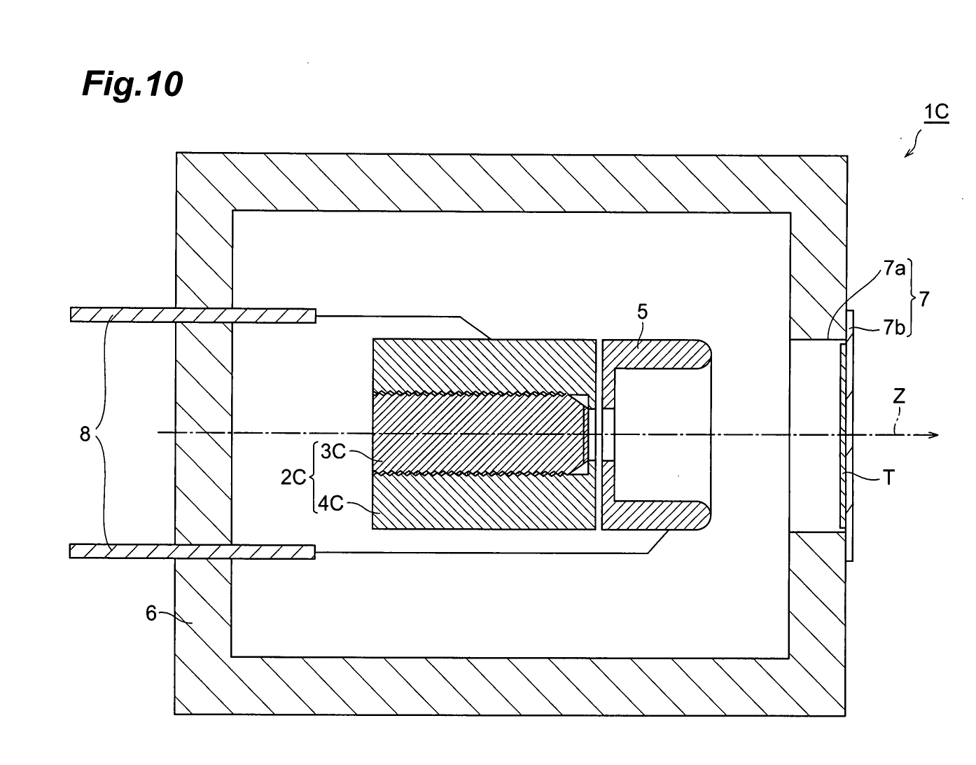

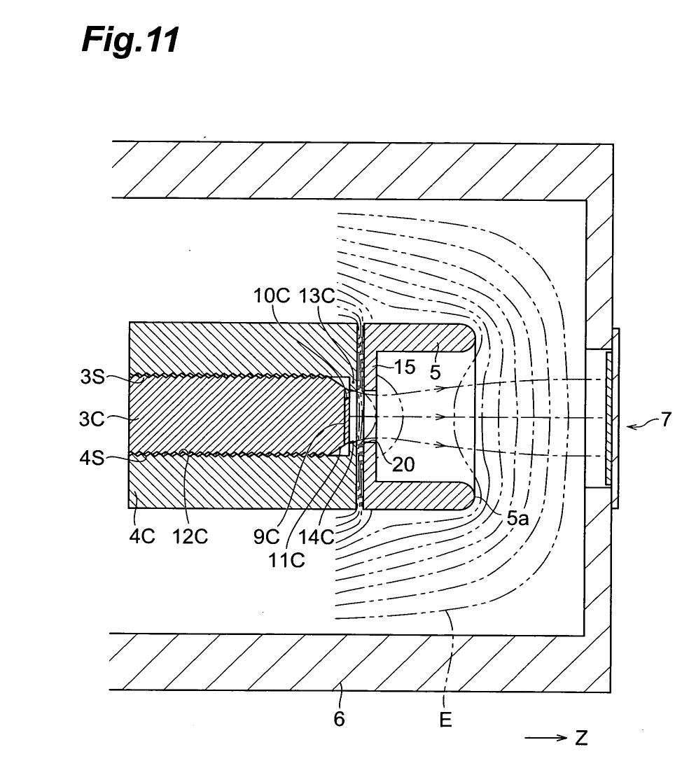

FIG. 10 is a sectional view taken along an axial direction of an X-ray tube according to a third embodiment of an electron tube according to the present invention. FIG. 11 is an enlarged sectional view of principal portions of the X-ray tube of FIG. 10. The X-ray tube 1C shown in FIG. 10 and FIG. 11 has a cold cathode electron source 2C that differs from the cold cathode electron source 2 according to the first embodiment. The components of the X-ray tube 1C besides the cold cathode electron source 2C are the same as those of the first embodiment.

With the cold cathode electron source 2C, a central conductor (first conductive member) 3C, formed of a cylindrical metal material, is screwed into a cylindrical outer conductor (second conductive member) 4C, made of a metal material. These are disposed so that a central axis of the central conductor 3C and a central axis of the outer conductor 4C are substantially matched and are parallel to the Z axis. As shown in FIG. 11, the central conductor 3C has a flat end face 9C at one end (front end). An inclined face 11C is formed by chamfering along an edge of the end face 9C. On an outer peripheral surface of the central conductor 3C, a male screw portion 3S is formed as a first screw portion. An electron emission layer 10C of an electron emitting material is formed as a film on the end face 9C. As the electron emitting material, the same material as the electron emitting material in the first embodiment may be used. Also, the same lamination method of the first embodiment may be used as the method of laminating the electron emission layer 10C onto the end face 9C.

The outer conductor 4C, disposed at an outer side of the central conductor 3C, has a hollow portion 12C of circular cross-sectional shape that passes through in the Z direction. An inner diameter of the hollow portion 12C is made substantially equal to an outer diameter of the central conductor 3C. On a wall face of the hollow portion 12C is formed a female screw portion (second screw portion) 4S with a shape enabling screw engagement with the male screw portion 3S. At a front end of the hollow portion 12C is provided a ring-shaped protrusion 13C that extends inward and substantially perpendicular to the central axis of the outer conductor 4C An opening portion 14C, having a circular cross section in a direction (second direction) parallel to the end face 9C and passing through toward the hollow portion 12C, is defined by the protrusion 13C. The hollow portion 12C and the opening portion 14C are formed so that the respective central axes thereof are substantially matched. The diameter of the opening portion 14C is made no greater than the diameter of the end face 9C of the central conductor 3C.

In assembling the cold cathode electron source 2C, the central conductor 3C is screwed into the hollow portion 12C of the outer conductor 4C, and a front face of the electron emission layer 10C of the central conductor 3C abuts the protrusion 13C of the outer conductor 4C. The central conductor 3C is thereby positioned, with respect to the outer conductor 4C, in the direction perpendicular to the end face 9C (first direction). Also by the male screw portion 3S of the central conductor 3C being put in screw engagement with the female screw portion 4S of the external conductor 4C, the central conductor 3C is positioned, with respect to the outer conductor 4C, in the direction parallel to the end face 9C and the central conductor 3C and the outer conductor 4C are made electrically continuous with each other. Furthermore, of the surface of the electron emission layer 10C of the central conductor 3C, a range defined by the opening portion 14C is exposed to the exterior from the opening portion 14C. In this case, by abutting the protrusion 13C, the central conductor 3C is disposed so that the electron emission layer 10C does not protrude frontward from a front end of the opening portion 14C.

Actions and effects of the X-ray tube 1C described above shall now be described with reference to FIG. 11.

When voltages are applied so that the potential of the extraction electrode 5 and the potential of the target T are higher than the potential of the central conductor 3C and the outer conductor 4C of the cold cathode electron source 2C, a spatial field is formed between the cold cathode electron source 2C and the target T. FIG. 11 shows isoelectric lines E of the electric field that is thus formed. By a comparatively strong electric field being formed in front of the electron emission layer 10C of the central conductor 3C by the extraction electrode 5 as shown in this figure, electrons are emitted frontward from the electron emission layer 10C. The emitted electrons pass through the opening 20 of the extraction electrode 5, are converged in the central axis direction by an electron lens formed by the open end 5a at the X-ray transmitting window 7 side of the extraction electrode 5, and are made incident on the target T efficiently. At the target T, X-rays are generated by the incidence of the electrons, and the generated X-rays are taken out frontward to the exterior from the X-ray transmitting window 7.

The amount of electrons emitted from the cold cathode electron source 2C in such an X-ray tube 1C varies according to the distance between the protrusion 15 of the extraction electrode 5 and the surface of the electron emission layer 10C, the thickness in the Z direction of the protrusion 13C at the cold cathode electron source 2C, and the positional relationship of the protrusion 13C and the surface of the electron emission layer 10C. As an example of an X-ray source, with which the amount of electrons emitted from the cold cathode is controlled by the extraction electrode, there is the arrangement described in Japanese Published Unexamined Patent Application No. 2001-250496. With this X-ray source, the cathode, the extraction electrode, and the Wehnelt electrode, which converges the emitted electrons onto the target, are disposed separately. Thus to obtain the desired electron emission amount, the cathode, the extraction electrode, and the Wehnelt electrode must be disposed at the respective positions without error.

In contrast, with the cold cathode electron source 2C, the central conductor 3C, having the electron emission layer 10C formed on the end face 9C, is screwed into the hollow portion 12C of the outer conductor 4C, and the central conductor 3C is positioned in the state of abutting the outer conductor 4C in the direction perpendicular to the end face 9C. By thus forming the central conductor 3C and the outer conductor 4C to be in a desired positional relationship, the positioning of the central conductor 3C with respect to the outer conductor 4C in the direction perpendicular to the end face 9C is achieved readily, and fluctuations of the electric field distribution in the periphery of the electron emission layer 10C due to fluctuations of the positional relationship of the central conductor 3C and the outer conductor 4C among cold cathode electron sources 2C of the same structure are reduced. Consequently, stable manufacture of the cold cathode electron sources 2C, having the same characteristics and the desired electron emission amount, can be realized, and by positioning the cold cathode electron source 2C as the electron source of the X-ray tube 1C at the predetermined position with respect to the extraction electrode, the X-ray tube 1C of the X-ray amount based on the desired electron emission amount can be obtained.

Also with the cold cathode electron source 2C, by the positioning of the central conductor 3C with respect to the outer conductor 4C in the direction parallel to the end face 9C being achieved by the screwing in at the same time, fluctuations of the electric field distribution in the periphery of the electron emission layer 10C due to fluctuations of the positional relationship of the central conductor 3C and the outer conductor 4C among cold cathode electron sources 2C of the same structure are reduced further. Stable manufacture of the cold cathode electron sources 2C, having the same characteristics and the desired electron emission amount, can thus be realized, and by positioning the cold cathode electron source 2C as the electron source of the X-ray tube 1C at the predetermined position with respect to the extraction electrode, the X-ray tube 1C of the X-ray amount based on the desired electron emission amount can be obtained.

Meanwhile, though in contrast to the arrangement of screwing the central conductor 3C into the outer conductor 4C, employment of an arrangement, in which an outer conductor and a central conductor are made integral, is also possible. In this case, the electron emitting material may become deposited on portions corresponding to being portions of the outer conductor, etc., in the process of forming the electron emission layer. As a result, such phenomena as emission of electrons in unexpected directions, discharge across other electrodes, etc., may occur. In regard to this point, because with the X-ray tube 1C, the outer conductor 4C and the central conductor 3C can be formed as separate members and the central conductor 3C can be incorporated in the hollow portion 12C of the outer conductor 4C after forming the electron emission layer 10C on the end face 9C, the deposition of the electron emitting material onto portions besides the end face 9C can be prevented. In this case, unintended electron emission and discharge from the electron emission layer 10C are prevented and the process of forming the electron emission layer 10C is made efficient.

Also because the inclined face 11C is formed by chamfering on the central conductor 3C, the central conductor 3C can be screwed smoothly into the outer conductor 4C, flawing of the surface of the electron emission layer 10C can be prevented, and the process of assembling the cold cathode electron source 2C is made efficient.

Also with the cold cathode electron source 2C, by the presence of the protrusion 13C that is equipotential to the central conductor 3C, the difference between the electric field strength at an edge of the electron emission layer 10C and the electric field strength at a center of the electron emission layer 10C can be reduced, and thus a uniform electron emission distribution can be obtained.

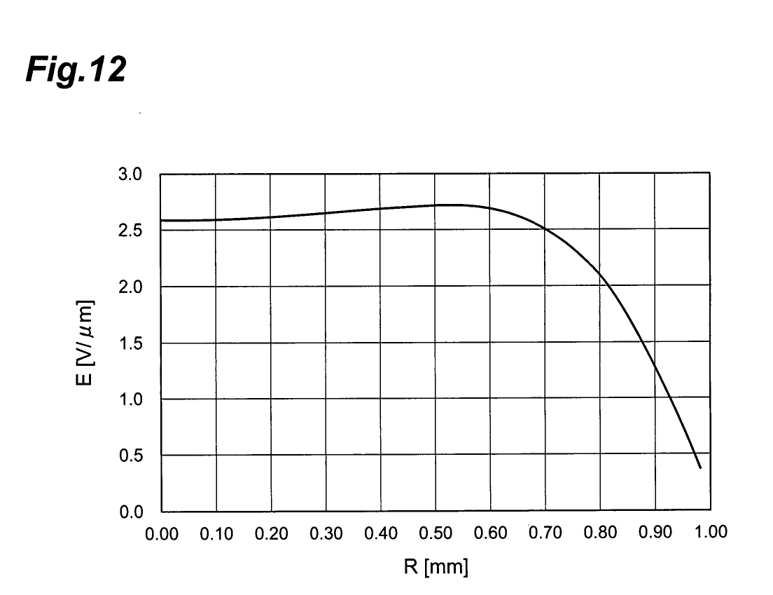

FIG. 12 is a graph of the electric field strength at the front face of the cold cathode electron source 2C of the X-ray tube of FIG. 11. Here, the diameter of the electron emission layer 10C of the cold cathode electron source 2C is 2.0 mm, the distance between the outer conductor 4C and the extraction electrode 5 is 0.25 mm, and voltages are applied to the respective electrodes so that the potential of the extraction electrode 5 is +2500V higher than the potential of the cold cathode electron source 2C. In this figure, the abscissa indicates the distance R [mm] from the central axis of the central conductor 3C near the electron emission layer 10C and the ordinate indicates the electric field strength E [V/μm] in the Z direction. As shown in the figure, the electric field strength in the Z direction near the electron emission layer 10C is maintained substantially fixed up to near R=0.70 [mm].

### Fourth Embodiment

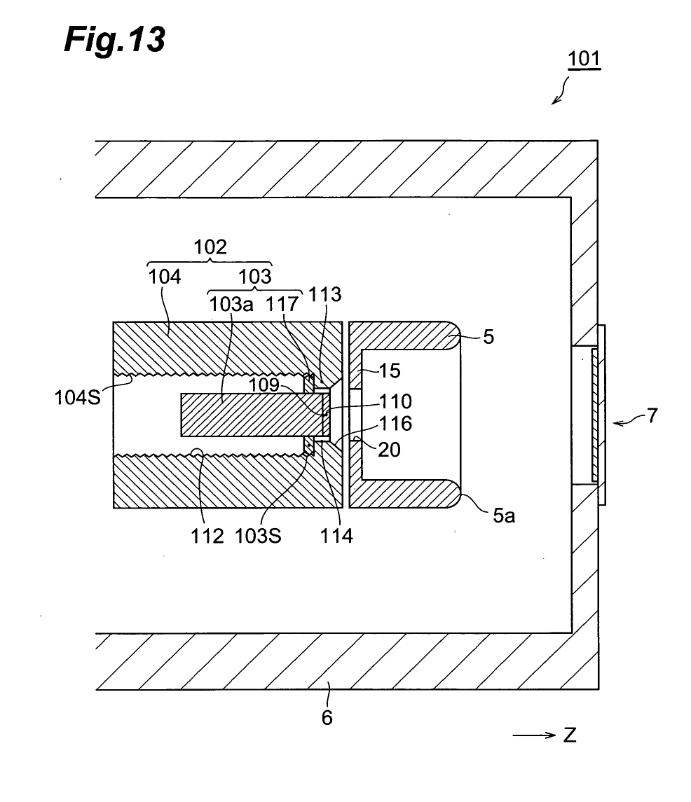

A fourth embodiment of the present invention shall now be described. FIG. 13 is an enlarged sectional view of principal portions taken along an axial direction of an X-ray tube according to the fourth embodiment of an electron tube according to the present invention. The X-ray tube 101 according to this embodiment differs from that of the third embodiment in the shapes of the central conductor and the outer conductor and in that the central conductor has an insulating portion.

That is, as shown in FIG. 13, with a cold cathode electron source 102, a central conductor (first conductive member) 103, having a conductive portion 103a formed of a cylindrical metal material, is screwed into a cylindrical outer conductor (second conductive member) 104, made of a metal material. A flat end face 109 is formed at one end (front end) of the central conductor 103, and an electron emission layer 110 of an electron emitting material is formed as a film on the end face 109.

The outer conductor 104 that is disposed at an outer side of the central conductor 103 has a hollow portion 112 of circular cross-sectional shape that passes through in the Z direction. The inner diameter of the hollow portion 112 is made larger than the outer diameter of the conductive portion 103a of the central conductor 103. On a wall face of the hollow portion 112, a female screw portion 104S is formed as a second screw portion. A ring-like protrusion 113 that extends inward and substantially perpendicular to a central axis of the outer conductor 104 is provided at a front end of the hollow portion 112. An inclined face 116 that spreads towards the front is formed on the protrusion 113. Also, an opening portion 114 that is circular in cross section in the direction parallel to the end face 109 and passes through toward the hollow portion 112 is defined by the protrusion 113 and the inclined face 116 that forms a portion of the protrusion 113. Here, the hollow portion 112 and the opening portion 114 are substantially matched in their respective central axes. The diameter of the opening portion 114 is made no less than the diameter of the end face 109 of the central conductor 103.

Furthermore, the central conductor 103 has a ring-like insulating portion 117 that is parallel to the end face 109. The insulating portion 117 is fixed to the conductive portion 103a and forms a portion of the outer surface of the central conductor 103. By this insulating portion 117, the central conductor 103 is enabled to be screwed into the hollow portion 112 in the direction perpendicular to the end face 109. That is, the outer diameter of the insulating portion 117 is substantially equal to the diameter (inner diameter) of the hollow portion 112. On an outer peripheral face of the insulating portion 117 is provided a male screw portion (first screw portion) 103S with a shape enabling screw engagement with the female screw portion 104S. The central conductor 103 is screwed into the hollow portion 112 by the screw engagement of the male screw portion 103S with the female screw portion 104S. When the central conductor 103 is completely screwed into the outer conductor 104, the insulating portion 117 abuts the protrusion 113. Here, by the insulating portion 117 abutting the protrusion 113, the electron emission layer 110 is positioned so as not to protrude frontward from the front end of the opening portion 114.

In assembling the cold cathode electron source 102, the central conductor 103 is screwed into the hollow portion 112 of the outer conductor 104 and the insulating portion 117 of the central conductor 103 abuts the external conductor 104. The central conductor 103 is thereby positioned in the direction perpendicular to the end face 109. By the male screw portion 103S of the insulating portion 117 being in screw engagement with the female screw portion 104S of the outer conductor 104, the central conductor 103 is positioned, with respect to the outer conductor 104, in the direction parallel to the end face 109. By the provision of the insulating portion 117, the central conductor 103 and the outer conductor 104 are electrically insulated from each other.

With the X-ray tube 101 described above, because the outer conductor 104 is electrically insulated from the central conductor 103, the potential of the outer conductor 104 can be set independently of the central conductor 103, and the amount of electrons extracted from the electron emission layer 110 can be controlled more finely while keeping fixed the electron converging effect by the extraction electrode 5. When the potential of the extraction electrode 5 is changed, because the field distribution in the space between the target T and the extraction electrode 5 changes as well, it is difficult to keep the electron converging effect fixed. However, this problem does not occur with the X-ray tube 101, with which the potential of the outer conductor 104 can be controlled.

Also, though the potential at the edge of the front face of the electron emission layer 110 tends to rise in comparison to the potential at a central portion, by supplying a lower potential to the outer conductor 104 than to the central conductor 103, the potential rise at the edge of the front face of the electron emission layer 110 can be restrained further to provide a more uniform electron emission distribution.

Furthermore, because by the inclined face 116 formed on the protrusion 113 of the outer conductor 104, the potential of the extraction electrode 5 can readily permeate to the open space in front of the electron emission layer 110, electrons are made readily emitted at a uniform emission distribution over a wide range frontward of the electron emission layer 110 and consequently, the electron emission amount increases.

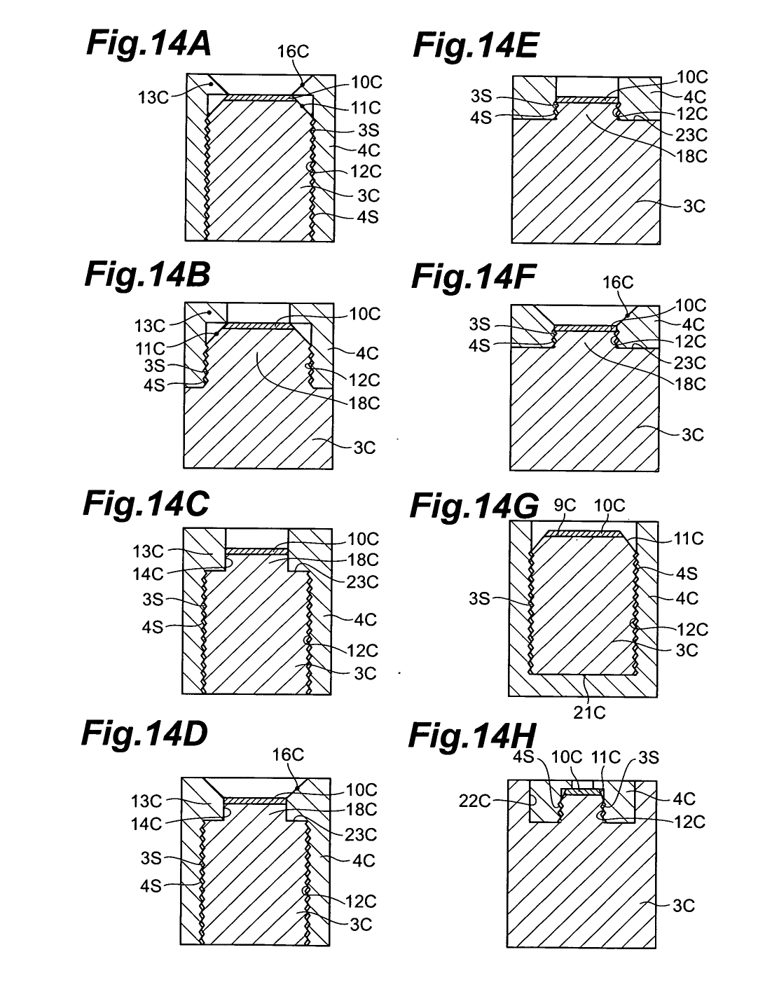

The present invention is not restricted to the third and fourth embodiments described above, and various shapes besides those described above may be employed as the shape of the cold cathode electron source. FIG. 14A to FIG. 14H show modification examples of the cold cathode electron source 2C according to the third embodiment. With the cold cathode electron source shown in FIG. 14A, an inclined face 16C that spreads toward the outer side is formed on the protrusion 13C of the outer conductor 4C, and the inclined face 11C is formed by chamfering along the edge of the end face at the electron emission layer 10C side of the central conductor 3C. With the cold cathode electron source shown in FIG. 14B, the central conductor 3C has a protruding portion 18C, which includes the end face at the electron emission layer 10C side, and is screwed into the outer conductor 4C by the screwing of the protruding portion 18C into the hollow portion 12C.

With each of the cold cathode electron sources shown in FIG. 14C and FIG. 14D, the central conductor 3C is screwed into the outer conductor 4C with the protruding portion 18C of the central conductor 3C being fitted into the opening portion 14C of the outer conductor 4C. The central conductor 3C is positioned in the axial direction by an end face 23C, which is perpendicular to an outer peripheral surface of the protruding portion 18C of the central conductor 3C, abutting the protrusion 13C. With each of the cold cathode electron sources shown in FIG. 14C and FIG. 14D, the positioning in the direction parallel to the end face 9C may be achieved by the protrusion 18C of the central conductor 3C being screwed into a screw portion formed on the wall face of the opening portion 14C. With each of the cold cathode electron sources shown in FIG. 14E and FIG. 14F, the outer conductor 4C does not have a protrusion 13C and one end of the hollow portion 12C serves in common as the opening portion 14C. The protruding portion 18C of the central conductor 3C is screwed into the hollow portion 12C.

With the cold cathode electron source shown in FIG. 14G, the outer conductor 4C has the hollow portion 12C, into which the central conductor 3C can be screwed from an end face 21C, disposed at the opposite side of the end face 9C and not having an electron emission layer formed thereon, and one end of the hollow portion 12C serves as the opening portion 14C. In this case, a penetrating hole for venting air may be provided at a portion of the outer conductor 4C that faces the end face 21C so that the central conductor 3C can be screwed readily into the hollow portion 12C. With the cold cathode electron source shown in FIG. 14H, a recess 22C that is substantially matched to the outer shape of the outer conductor 4C is formed in the central conductor 3C. When the central conductor 3C is screwed into the hollow portion 12C of the outer conductor 4C, the outer conductor 4C is fitted into the recess of the central conductor 3C at the same time. With each of the cold cathode electron sources shown in FIG. 14A, FIG. 14B, FIG. 14G, and FIG. 14H, the inclined face 11C does not have to be formed. Also with each of the cold cathode electron sources shown in FIG. 14C to FIG. 14F, the inclined face 11C may be formed. Likewise, with each of the cold cathode electron sources shown in FIG. 14B, FIG. 14G, and FIG. 14H, the inclined face 16C may be formed.

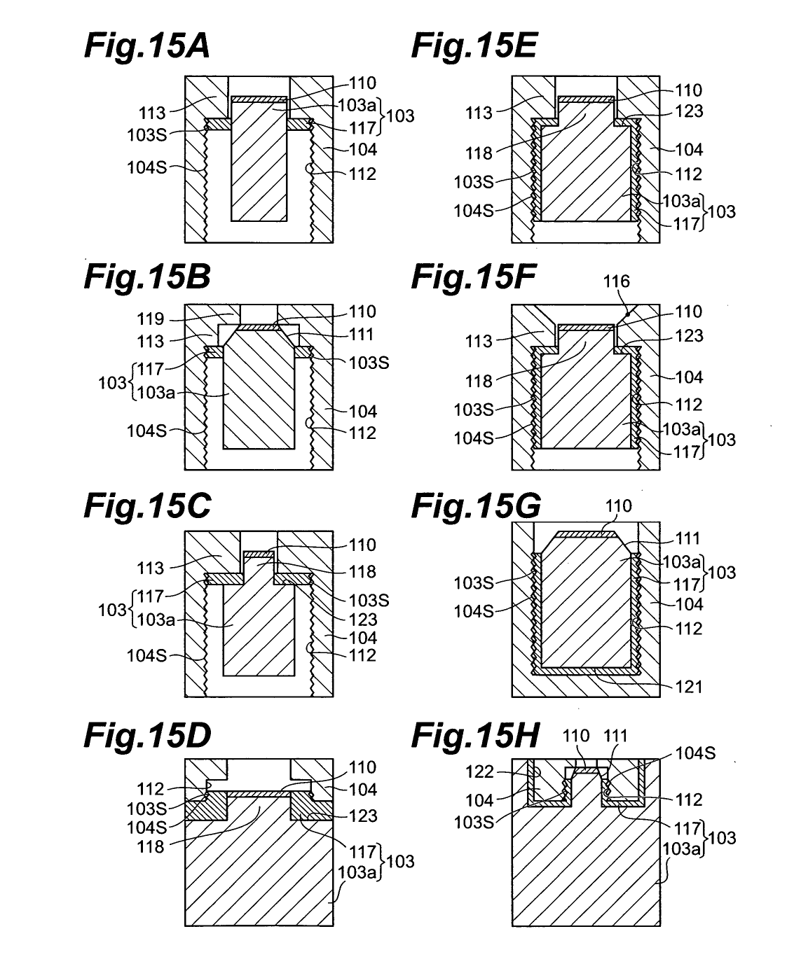

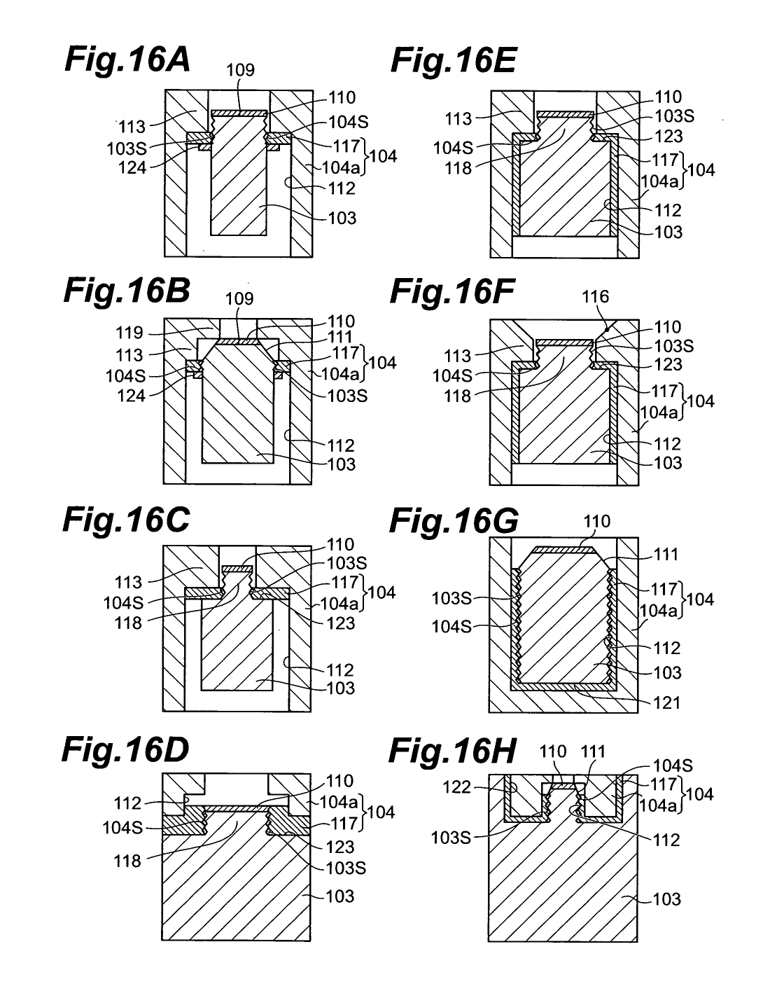

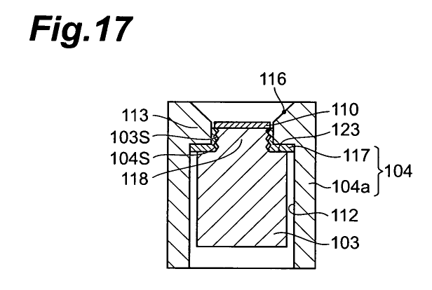

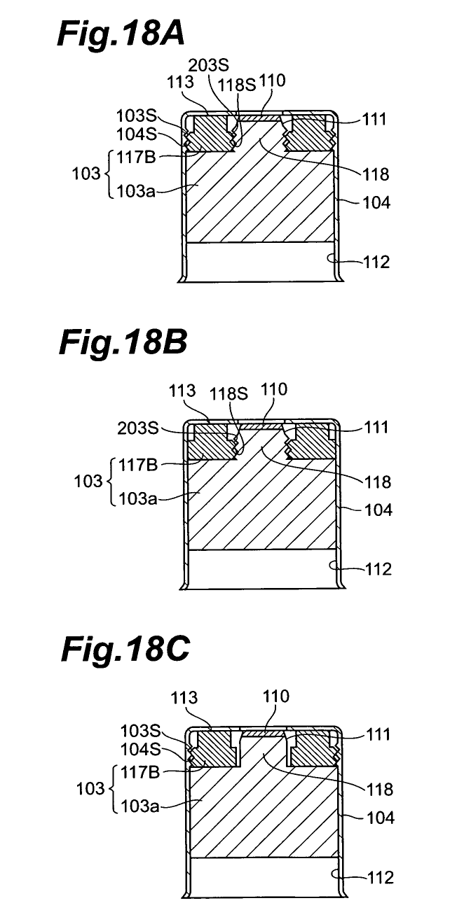

FIG. 15A to FIG. 15H show modification examples of the cold cathode electron source 102 according to the fourth embodiment. FIG. 15A shows an example of the cold cathode electron source that does not have the inclined face 116. With the cold cathode electron source shown in FIG. 15B, an inclined face 111 is formed by chamfering along the end face 109 of the central conductor 103, and a ring-like protrusion 119 is formed at an outer side in the axial direction of the protrusion 113 of the outer conductor 104. The inner diameter of the protrusion 119 is made substantially equal to the diameter of the end face 109 of the central conductor 103 and the protrusion 119 and the electron emission layer 110 are disposed so as not to contact each other.

With each of the cold cathode electron sources shown in FIG. 15C and FIG. 15D, a protruding portion 118 is formed on an electron emission side end face of the conductive portion 103a of the central conductor 103, and this protruding portion 118 is inserted into the hollow portion 112 and is positioned via the insulating portion 117. With the cold cathode electron source shown in FIG. 15D, by the insulating portion 117 abutting the end face of the outer conductor 104 at the inserting side, the central conductor 103 is positioned in the axial direction.

In contrast to the cold cathode electron source shown in FIG. 15C, each of the cold cathode electron sources shown in FIG. 15E and FIG. 15F has an arrangement in which the insulating portion 117 is formed and fixed on the entire side face of the conductive portion 103a of the central conductor 103 and on an end face 123 that is perpendicular to an outer peripheral surface of the protruding portion 118. With each of the cold cathode electron sources shown in FIG. 15E and FIG. 15F, an insulating portion may furthermore be provided on the outer periphery of the protruding portion 118 In this case, the positioning in the direction parallel to the end face 109 may be achieved by the protruding portion 118 of the central conductor 103 being screwed into a screw portion formed on a wall face of the opening portion 114. FIG. 15G and FIG. 15H show cold cathode electron sources with shapes corresponding to those of FIG. 14G and FIG. 14H and having the insulating portion 117. With the cold cathode electron source shown in FIG. 15G, to make the central conductor 103 fit readily into the hollow portion 112 or to secure electrical connection to the central conductor 103, penetrating holes may be provided at portions of both the insulating portion 117 and the outer conductor 104 that face the end face 121. With each of the cold cathode electron sources shown in FIG. 15B, FIG. 15C, and FIG. 15H, the inclined face 111 does not have to be formed. Also with each of the cold cathode electron sources shown in FIG. 15A and FIG. 15C to FIG. 15F, the inclined face 111 may be formed. Likewise, with each of the cold cathode electron sources shown in FIG. 15B to FIG. 15D, FIG. 15Q and FIG. 15H, the inclined face 116 may be formed.

Though with the cold cathode electron source 102 described above, the insulating portion 117 is fixed to the outer peripheral surface of the conductive portion 103a of the central conductor 103, the insulating portion 117 may be fixed instead to a wall face of a cylindrically shaped conductive portion 104a of the outer conductor 104. In this case, the insulating portion 117 forms at least a portion of the inner wall of the external conductor 104. With this arrangement, the male screw portion 103S is formed on the outer peripheral surface of the central conductor 103, and the female screw portion 104S is formed on the insulating portion 117. FIG. 16A to FIG. 16H show modification examples of the cold cathode electron source according to the second embodiment with such an arrangement.

The cold cathode electron sources shown in FIG. 16A to FIG. 16H correspond respectively to the arrangements shown in FIG. 15A to FIG. 15H. With each of the cold cathode electron sources shown in FIG. 16A to FIG. 16H, the insulating portion 117 is fixed on the wall face of the conductive portion 104a of the outer conductor 104. By the screw engagement of the male screw portion 103S on the outer peripheral surface of the central conductor 103 with the female screw portion 104S on the insulating portion 117, the central conductor 103 is screwed into the outer conductor 104 and the central conductor 103 abuts the insulating portion 117 of the outer conductor 104 in the axial direction.

Specifically, with each of the cold cathode electron sources shown in FIG. 16A and FIG. 16B, the central conductor 103 has, on its outer periphery, a stopper portion 124 that extends in the direction parallel to the end face 109. The central conductor 103 is set in a desired positional relationship with respect to the outer conductor 104 by abutting, via the stopper portion 124, the insulating portion 117 in the direction of insertion when the central conductor 103 is screwed into the outer conductor 104. Consequently, the central conductor 103 is positioned in the direction perpendicular to the end face 109. The stopper portion 124 may be formed integral to the central conductor 103 or may be fixed to the central conductor 103.

With the cold cathode electron source shown in FIG. 16G, to make the central conductor 103 be screwed readily into the hollow portion 112 or to secure electrical connection to the central conductor 103, penetrating holes may be provided at portions of both the insulating portion 117 and the conductive portion 104a of the outer conductor 104 that face the end face 221. With each of the cold cathode electron sources shown in FIG. 16B, FIG. 16G, and FIG. 16H, the inclined face 111 does not have to be formed. Also with each of the cold cathode electron sources shown in FIG. 16A and FIG. 16C to FIG. 16F, the inclined face 111 may be formed. Likewise, with each of the cold cathode electron sources shown in FIG. 16B to FIG. 16D, FIG. 16G, and FIG. 16H, the inclined face 116 may be formed.

Though with the cold cathode electron source 102 shown in FIG. 16F, the wall face of the hollow portion 112 of the outer conductor 104 is formed of the insulating portion, the wall face of the opening portion 114 of the outer conductor 104 may be formed of the insulating portion instead and the female screw portion may be provided on the insulating portion. FIG. 17 shows a modification example of the cold cathode electron source according to the fourth embodiment with such an arrangement. Even with this arrangement, the central conductor 103 is screwed into the external conductor 104, and the central conductor 103 abuts the insulating portion 117 in the axial direction.

With the cold cathode electron sources 2C and 102, male screw portions may be formed on the outer conductors 4C and 104 and female screw portions may be formed on the central conductors 3C and 103.

The cold cathode electron sources shown in FIG. 18A to FIG. 18C correspond to the arrangement shown in FIG. 9A. FIG. 18A to FIG. 18C show modification examples of the cold cathode electron source according to the fourth embodiment.

With the cold cathode electron source shown in FIG. 18A, a male screw portion 103 S is formed on an outer peripheral surface of the conductive portion 117B. On a wall face of the hollow portion 112 is formed a female screw portion 104S with a shape enabling screw engagement with the male screw portion 103S. As a result, the central conductor 103 is screwed into the external conductor 104, and the central conductor 103 abuts a ring-like conductive portion 117B in the axial direction.

On an inner peripheral surface of the conductive portion 117B, a female screw portion 203S is formed. On an outer surface of the protruding portion 118 is formed a male screw portion 118S with a shape enabling screw engagement with the female screw portion 203S. As a result, the conductive portion 103a is screwed into the opening of conductive portion 117B, and the conductive portion 103a abuts the conductive portion 117B.

With the cold cathode electron source shown in FIG. 18B, a male screw portion 103S is not formed on an outer peripheral surface of the conductive portion 117B. On an inner peripheral surface of the conductive portion 117B, a female screw portion 203S is formed.

With the cold cathode electron source shown in FIG. 18C, a female screw portion 203S is not formed on an inner peripheral surface of the conductive portion 117B. On an outer peripheral surface of the conductive portion 117B, a male screw portion 103S is formed.

As described above, a cold cathode electron source includes: a first conductive member, having an end face and an electron emitting layer that is formed on the end face and made of an electron emitting material; and a second conductive member, having a hollow portion that enables insertion of the first conductive member in a first direction substantially perpendicular to the end face, and an opening portion that passes through toward the hollow portion; and wherein the first conductive member is fitted into the second conductive member, is positioned in the first direction with respect to the second conductive member by abutting the second conductive member in the first direction, the first conductive member exposing a surface of the electron emission layer from the opening portion. The first conductive member may be fitted into the hollow portion of the second conductive member.

The second conductive member is thus a member having an open end and an inner wall that defines a space, which is continuous with an opening of the open end. At least the end face and the electron emission layer are housed in the space. The first conductive member is fitted into the space of the second conductive member with the electron emission layer facing the opening and abuts the second conductive member in the first direction.

With this cold cathode electron source, the first conductive member, with the electron emission formed on the end face, is fitted into the second conductive member, and the first conductive member is positioned in a state of abuting the second conductive member in the first direction perpendicular to the end face. By thus forming the first conductive member and the second conductive member to be in a desired positional relationship, the positioning of the first conductive member with respect to the second conductive member in the first direction perpendicular to the end face is achieved readily, and fluctuations of an electric field distribution in a periphery of the electron emission layer due to fluctuations of the positional relationship of the first conductive member and the second conductive member among electron sources of the same structure are reduced. Consequently, cold cathode electron sources, having the same characteristics and the desired electron emission amount, can be provided in a stable manner. Also, because the opening portion, which exposes the electron emission layer in the state in which the first conductive member abuts the second conductive member, is formed in the second conductive member, an electron emission range of the electron emission layer is set readily.

Preferably, the first conductive member is furthermore positioned in a second direction substantially parallel to the end face with respect to the second conductive member by a side face of the first conductive member contacting the inner wall of the second conductive member. In this case, because positioning of the first conductive member with respect to the second conductive member in a second direction parallel to the end face is achieved as well, fluctuations of the electric field distribution in the periphery of the electron emission layer due to fluctuations of the positional relationship of the first conductive member and the second conductive member among electron sources of the same structure are reduced further. Cold cathode electron sources, having the same characteristics and the desired electron emission amount, can thus be provided in a stable manner.

Preferably, the first conductive member has an insulating portion that forms at least a portion of an outer surface thereof, and the insulating portion abuts the second conductive member in the first direction. In this case, because the first conductive member is positioned with respect to the second conductive member in the first direction perpendicular to the end face, and voltages can be supplied so that the first conductive member and the second conductive member differ in potential, the amount of electrons emitted from the electron emission layer can be controlled more finely. Here, the “outer surface” of the first conductive member refers to the entire outer surface besides the surface on which the electron emission layer is formed.

Preferably in addition, the insulating portion of the first conductive member forms at least a portion of the side face of the first conductive member and contacts the inner wall of the second conductive member. In this case, because the first conductive member is positioned with respect to the second conductive member in the second direction parallel to the end face, and voltages can be supplied so that the first conductive member and the second conductive member differ in potential, the amount of electrons emitted from the electron emission layer can be controlled more finely.

Also preferably, the second conductive member has an insulating portion that forms at least a portion of the inner wall of the second conductive member, and the first conductive member abuts the insulating portion of the second conductive member in the first direction. Because by employing this arrangement, the first conductive member is positioned with respect to the second conductive member in the first direction perpendicular to the end face, and voltages can be supplied so that the first conductive member and the second conductive member differ in potential, the amount of electrons emitted from the electron emission layer can be controlled more finely.

Preferably in addition, the side face of the first conductive member contacts the insulating portion of the second conductive member. In this case, because the first conductive member is positioned with respect to the second conductive member in the second direction parallel to the end face, and voltages can be supplied so that the first conductive member and the second conductive member differ in potential, the amount of electrons emitted from the electron emission layer can be controlled more finely.

Furthermore, a cold cathode electron source includes a first conductive member, having an end face, an electron emission layer that is formed on the end face and made of an electron emitting material, and a first screw portion that is formed on a side face; and a second conductive member, having a hollow portion that enables insertion of the first conductive member in a first direction substantially perpendicular to the end face, an opening portion that passes through toward the hollow portion, and a second screw portion that is formed on at least either one of a wall face of the hollow portion and a wall face of the opening portion and is screw engageable with the first screw portion; and wherein the first conductive member is positioned, with respect to the second conductive member, in a second direction substantially parallel to the end face by the first screw portion and the second screw portion being screwed together, the first conductive member being positioned in the first direction with respect to the second conductive member by abutting the second conductive member in the first direction, the first conductive member exposing a surface of the electron emission layer from the opening portion.

The second conductive member is thus a member having an open end and an inner wall that defines a space, which is continuous with an opening of the open end. The second screw portion is formed on the inner wall of the second conductive member. At least the end face and the electron emission layer are housed in the space provided by the second conductive member. The first conductive member is screwed into the second conductive member with the electron emission layer facing the opening and abuts the second conductive member in the first direction.

With this cold cathode electron source, the first conductive member, with the electron emission layer formed on the end face, is screwed into the hollow portion of the second conductive member, and the first conductive member is positioned in a state of abutting the second conductive member in the first direction perpendicular to the end face. By thus forming the first conductive member and the second conductive member to be in a desired positional relationship, the positioning of the first conductive member with respect to the second conductive member in the first direction perpendicular to the end face is achieved readily, and fluctuations of an electric field distribution in a periphery of the electron emission layer due to fluctuations of the positional relationship of the first conductive member and the second conductive member among electron sources of the same structure are reduced. Consequently, cold cathode electron sources, having the same characteristics and the desired electron emission amount, can be provided in a stable manner. Also because by the screwing in, the positioning of the first conductive member with respect to the second conductive member in the second direction parallel to the end face is achieved at the same time and because the electron emission layer is exposed from the opening portion in the state in which the first conductive member abuts the second conductive member, an electron emission range of the electron emission layer is set readily.

Furthermore, preferably, the first conductive member has an insulating portion that forms at least a portion of an outer surface thereof, wherein the first screw portion is formed on the insulating portion, and wherein the insulating portion abuts the second conductive member in the first direction. In this case, because the first conductive member is positioned with respect to the second conductive member in the first direction perpendicular to the end face, and voltages can be supplied so that the first conductive member and the second conductive member differ in potential, the amount of electrons emitted from the electron emission layer can be controlled more finely. Here, the “outer surface” of the first conductive member refers to the entire outer surface besides the surface on which the electron emission layer is formed.

Furthermore, preferably, the second conductive member has an insulating portion that forms at least a portion of the inner wall thereof, wherein the second screw portion is formed on the insulating portion, and wherein the first conductive member abuts the insulating portion of the second conductive member in the first direction. In this case, because the first conductive member is positioned with respect to the second conductive member in the first direction perpendicular to the end face, and voltages can be supplied so that the first conductive member and the second conductive member differ in potential, the amount of electrons emitted from the electron emission layer can be controlled more finely.

With any of the above-described cold cathode electron sources, an edge of the end face of the first conductive member is preferably chamfered. When such a first conductive member is provided, the first conductive member is fitted or screwed smoothly into the second conductive member and the manufacturing process is made efficient.

Furthermore, with any of the above-described cold cathode electron sources, an inclined face that spreads as the open end is approached is formed at the opening portion of the second conductive member. By this arrangement, because the potential permeates more broadly near the electron emission layer, the amount of electrons emitted from the electron emission layer increases.

Yet furthermore, with any of the above-described cold cathode electron sources, the electron emitting material contains carbon nanotubes. By this arrangement, the electrons emitted from the cold cathode can be obtained with stability and at a low consumption power.

An electron tube comprises: any of the above-described cold cathode electron sources; and a vacuum container that houses the cold cathode electron source.

By positioning the above-described cold cathode electron source in the vacuum container, electron tubes, having the same characteristics and having an electron source of uniform electron emission amount, can be provided in a stable manner. Consequently, electron tubes, having the same characteristics and enabled to cause a uniform amount of electrons incident on a target, etc., can be provided in a stable manner.

The electron tube preferably furthermore has an extraction electrode, disposed at a predetermined position with respect to the cold cathode electron source and having an opening formed therein. In this case, by the cold cathode electron source being positioned at the predetermined position with respect to the extraction electrode, the amount of electrons emitted from the cold cathode electron source and a range of incidence onto a target can be controlled more accurately.

With the cold cathode electron source according to the present invention, stable manufacture of electron sources, having the same characteristics and being adjusted in electron emission amount, can be realized readily.

What is claimed is:

1. A cold cathode electron source comprising:
a first conductive member, having an end face and an electron emission layer that is formed on the end face and made of an electron emitting material; and
a second conductive member, having a hollow portion that enables insertion of the first conductive member in a first direction substantially perpendicular to the end face, and an opening portion that passes through toward the hollow portion; and
wherein the first conductive member is fitted into the second conductive member, is positioned in the first direction with respect to the second conductive member by abutting the second conductive member in the first direction, the first conductive member exposing a surface of the electron emission layer from the opening portion.

2. The cold cathode electron source according to claim 1, wherein the first conductive member is fitted into the hollow portion.

3. The cold cathode electron source according to claim 1, wherein the first conductive member is furthermore positioned in a second direction substantially parallel to the end face with respect to the second conductive member by a side face of the first conductive member contacting an inner wall of the second conductive member.

4. The cold cathode electron source according to claim 3, wherein the first conductive member has an insulating portion that forms at least a portion of an outer surface thereof, and the insulating portion abuts the second conductive member in the first direction.

5. The cold cathode electron source according to claim 4, wherein the insulating portion forms at least a portion of the side face of the first conductive member and contacts the inner wall.

6. The cold cathode electron source according to claim 3, wherein the second conductive member has an insulating portion that forms at least a portion of the inner wall, and the first conductive member abuts the insulating portion in the first direction.

7. The cold cathode electron source according to claim 6, wherein the side face of the first conductive member contacts the insulating portion.

8. A cold cathode electron source comprising:
a first conductive member, having an end face, an electron emission layer that is formed on the end face and made of an electron emitting material, and a first screw portion that is formed on a side face; and
a second conductive member, having a hollow portion that enables insertion of the first conductive member in a first direction substantially perpendicular to the end face, an opening portion that passes through toward the hollow portion, and a second screw portion that is formed on at least either one of a wall face of the hollow portion and a wall face of the opening portion and is screw engageable with the first screw portion; and
wherein the first conductive member is positioned, with respect to the second conductive member, in a second direction substantially parallel to the end face by the first screw portion and the second screw portion being screwed together, the first conductive member being positioned in the first direction with respect to the second conductive member by abutting the second conductive member in the first direction, the first conductive member exposing a surface of the electron emission layer from the opening portion.

9. The cold cathode electron source according to claim 8, wherein the first conductive member has an insulating portion that forms at least a portion of an outer surface thereof,
wherein the first screw portion is formed on the insulating portion, and
wherein the insulating portion abuts the second conductive member in the first direction.

10. The cold cathode electron source according to claim 8, wherein the second conductive member has an insulating portion that forms at least a portion of an inner wall thereof,
wherein the second screw portion is formed on the insulating portion, and
wherein the first conductive member abuts the insulating portion in the first direction.

11. The cold cathode electron source according to claim 1, wherein an edge of the end face of the first conductive member is chamfered.

12. The cold cathode electron source according to claim 1, wherein an inclined face that spreads as an open end is approached is formed on the opening portion of the second conductive member.

13. The cold cathode electron source according to claim 1, wherein the electron emitting material contains carbon nanotubes.

14. An electron tube comprising:
the cold cathode electron source according to claim 1; and
a vacuum container, housing the cold cathode electron source.

15. The electron tube according to claim 14, further comprising: an extraction electrode, disposed at a predetermined position with respect to the cold cathode electron source and having an opening formed therein.

16. The cold cathode electron source according to claim 8, wherein an edge of the end face of the first conductive member is chamfered.

17. The cold cathode electron source according to claim 8, wherein an inclined face that spreads as an open end is approached is formed on the opening portion of the second conductive member.

18. The cold cathode electron source according to claim 8, wherein the electron emitting material contains carbon nanotubes.

19. An electron tube comprising:
the cold cathode electron source according to claim 8; and
a vacuum container, housing the cold cathode electron source.

20. The electron tube according to claim 19, further comprising: an extraction electrode, disposed at a predetermined position with respect to the cold cathode electron source and having an opening formed therein.
